(19) United States
(12) Patent Application Publication
(10) Pub. No.: US 2009/0264195 A1
(43) Pub. Date: Oct. 22, 2009

(54) ADJUSTABLE GAMING DISPLAY AND RELATED METHODS

(75) Inventor: Vijay Krishna Kompella, Las Vegas, NV (US)

Correspondence Address: STEPTOE & JOHNSON, LLP, 2121 AVENUE OF THE STARS, SUITE 2800, LOS ANGELES, CA, 90067, US

(73) Assignee: Bally Gaming, Inc., Las Vegas, NV (US)

(21) Appl. No.: 12/106,940

(22) Filed: Apr. 21, 2008

(51) Int. Cl. A63F 13/08; A63F 9/24

(52) U.S. Cl. 463/31; 463/43; 463/37; 463/46

(57) ABSTRACT

Methods for tailoring a gaming machine to a player are disclosed herein. According to one method, a first gaming machine receives a player input via a player interface to tilt a display. The display pivots about a horizontal axis of the display in response to the player input from the player interface, and data related to the position of the display is saved. The data is then associated with a player identifier for future use on the first gaming machine or a gaming machine having a similar display configuration.

### CROSS-REFERENCE TO RELATED APPLICATIONS

This application is related to co-pending U.S. patent application Ser. No. 12/106,904 concurrently filed on Apr. 21, 2008, entitled ADJUSTABLE GAMING DISPLAY.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE EMBODIMENTS

Embodiments disclosed herein relate to gaming machines having one or more adjustable displays.

### BACKGROUND

The gaming industry often utilizes gaming machines that are networked via a central computer. Gaming machines are devices that provide for wagering games such as poker, blackjack, and other games of chance, skill, or combinations therein. Currently, gaming machines are produced in many forms including uprights, tabletop machines, and handheld units.

In many gaming establishments, players register demographic information for tracking purposes and obtain a player card. Typical player cards include a unique player identifier issued by the gaming establishment. Use of the player identifier enables the casino to centrally track the player's wagering activity. Applying the player's historic gaming activity, the gaming establishment can develop a targeted marketing campaign including promotions, gifts, and advertisements to a player.

Additionally, the player card can be enabled for cashless gaming. In a cashless gaming environment, the player can deposit funds at a designated station or device and have funds automatically transferred to a player account. With this benefit, the player can avoid carrying large amounts of currency from machine to machine and from casino to casino.

To further enhance the excitement of wagering, many gaming machines are configured to provide bonus games. A bonus game is a wagering game in addition to, or in conjunction with, a base wagering game that provides an opportunity to win an amount or value that is separate than what is expected from the base wagering game.

### SUMMARY

Briefly, and in general terms, various embodiments of apparatuses and methods are directed to gaming machines having one or more adjustable displays. According to one embodiment, the gaming machine includes a first display and an adjustable display mounted in a gaming cabinet where the adjustable display is rotatable about a horizontal axis of the adjustable display. The gaming machine also includes a motor operatively coupled to the adjustable display. A player tracking device is also located on the gaming cabinet. The player tracking device is capable of receiving player-specific information. A controller is operatively coupled to the motor and the player tracking device. The controller causes the motor to rotate the adjustable display to a position based on the player-specific information received by the player tracking device.

In another embodiment, the gaming machine includes a first display and an adjustable display mounted in a gaming cabinet where the adjustable display is rotatable about a horizontal axis of the adjustable display. The gaming machine also includes a motor operatively coupled to the adjustable display. The gaming machine is provided with player interface for receiving player input to rotate the adjustable display. A controller is operatively coupled to the motor and the player interface. The controller causes the motor to rotate the adjustable display to a position based on the player input received by the player interface.

In yet another embodiment, the gaming machine includes a first display and an adjustable display mounted in a gaming cabinet where the adjustable display is rotatable about a horizontal axis of the adjustable display. The gaming machine also includes a motor operatively coupled to the adjustable display. The gaming machine is also provided with a player interface for receiving player input to rotate the adjustable display. A controller is operatively coupled to the motor and the player interface. The controller causes the motor to rotate the adjustable display to a position based on the player input received by the player interface. The gaming machine also includes a player tracking device. The player tracking device is in communication with the controller, and the player tracking device is capable of saving the position of the adjustable display for future use.

In addition to gaming machines, methods for tailoring a gaming machine to a player are also disclosed herein. According to one method, a first gaming machine receives player input via a player interface to tilt a display. The display pivots about a horizontal axis of the display in response to the player input from the player interface, and data related to the position of the display is saved. The data is then associated with a player identifier for future use on the first gaming machine or a gaming machine having a similar display configuration.

According to another method, the configuration of the display is savable and usable on the same or similar gaming machines. In one method, a first gaming machine receives a first gaming machine receives player input via a player interface to tilt a display. The display pivots about a horizontal axis of the display in response to the player input from the player interface, and data related to the position of the display is saved. The data is then associated with a player identifier for future use on the first gaming machine or a gaming machine having a similar display configuration. The player identifier is then received on a second gaming machine. A determination is made to whether the data relating to the position of a display is applicable to the second gaming machine. If applicable, the display is automatically pivoted to the position according to the data associated with the player identifier.

According to yet another method, the gaming machine automatically adjusts a display to a player. In one method, the gaming machine identifies the top of the player's head relative to an adjustable display. The adjustable display is then pivoted to a position such that the player's line of sight is approximately perpendicular to the adjustable display. Data including the position of the adjustable display is savable to a player account.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 is a perspective view of an embodiment of a gaming machine having an adjustable display.

FIG. 2 is a perspective view of another embodiment of a gaming machine having an adjustable display.

FIG. 3 is a perspective view of yet another embodiment of a gaming machine having an adjustable display.

FIG. 4 is a side view of an embodiment of a gaming machine having an adjustable display.

FIG. 5 is a side view of one embodiment of a gaming machine having two adjustable displays.

FIG. 6 is a flow chart of one method of adjusting a gaming display.

FIG. 7 is a flow chart of another method of adjusting a gaming display.

FIG. 8 is a flow chart of yet another method of adjusting a gaming display.

FIG. 9 is a flow chart of another method of adjusting a gaming display.

### DETAILED DESCRIPTION

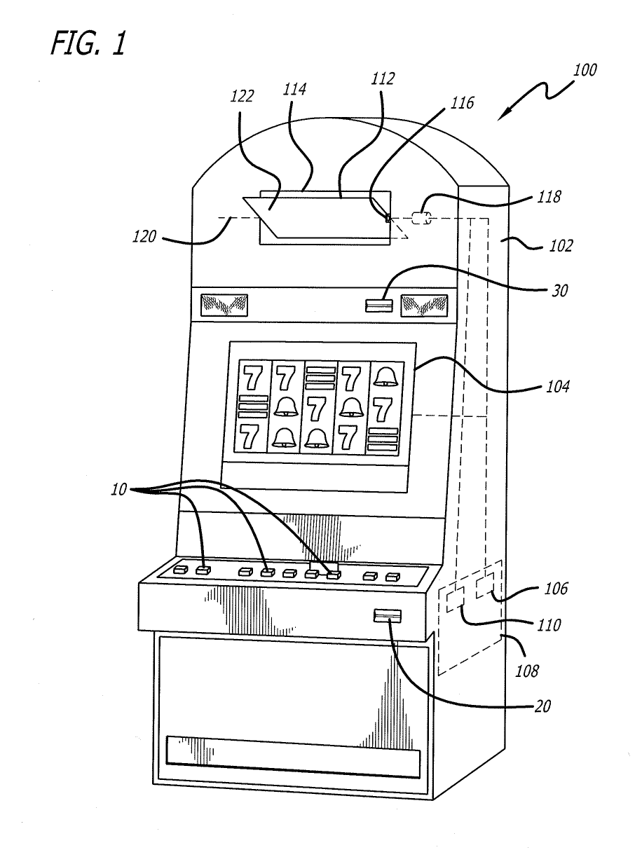

Referring now to the drawings, wherein like reference numerals denote like or corresponding parts throughout the drawings and, more particularly to FIGS. 1-5, there are shown various embodiments of a gaming machine having a primary display and an adjustable display. More specifically, as shown in FIG. 1, there is disclosed a gaming machine 100 having an upright gaming cabinet 102. The gaming cabinet 102 provides structural support and houses the components of the gaming machine 100. In addition, the gaming cabinet 102 is secured to prevent access to electronics and currency disposed within the gaming machine 100.

As shown in FIG. 1, the first display 104 is fixed within the cabinet 102. In another embodiment, the first display 104 is pivotally mounted within the cabinet 102. Additionally, the second display 112 is positioned above the first display 104. In one embodiment, the second display 112 is smaller than the first display 104. As those skilled in the art will appreciate, the second display 112 may be positioned below the first display 104 or any location on the gaming machine 100 within the line-of-sight of a player.

Control of the first display 104 is managed by the electronics assembly 108. The electronics assembly 108 includes a computing device which processes inputs and generates outputs. Common computing devices in a gaming environment include PC based configurations. However, in additional embodiments (not shown), application specific integrated circuits provide efficient processing of a fixed set of tasks such as, but not limited to, receiving a wager or generating a game outcome. As shown in FIG. 1, the electronics assembly 108 is disposed within the cabinet 102 and includes a processor 106 and a controller 110. The processor 106 is enabled to execute software and/or firmware. The controller 110 includes circuitry for controlling a peripheral device, e.g., the first display 104, the second display 112, and/or other peripherals.

According to one embodiment, the displays 104, 112 are flat panel displays including by way of example only, and not by way of limitation, liquid crystal, plasma, electroluminescent, vacuum fluorescent, field emission, LCOS (liquid crystal on silicon), and SXRD (Silicon Xtal Reflective display), Laser, or any other type of panel display known or developed in the art. These flat panel displays may use panel technologies to provide digital quality images including by way of example only, and not by way of limitation, EDTV, HDTV, or DLP (Digital Light Processing). In another embodiment, the flat panel displays are widescreen displays that are mounted in the gaming cabinet in a portrait or landscape orientation. In other embodiments, the displays 104, 112 are cathode ray tube monitors or projection monitor displays. Further, the displays 104, 112 can include touch screen features and/or electronics for network communications.

As shown in FIG. 1, the first display 104 presents a five-reel video slots game. Alternatively, more or fewer reels may be used. In other embodiments, the five-reel video slot game can be replaced by any game, including mechanical slots, video keno, video poker, video blackjack, video roulette, Class II bingo, games of skill, or games of chance involving some player skill. For the sake of brevity and clarity, the following disclosure and examples of the game is a slot-type game, but those skilled in the art will appreciate that any of the above-referenced games or others may be presented in the gaming machine 100.

The second display 112 is disposed at least partially within a recessed section 114 of the cabinet 102. In one embodiment, the second display augments or supplements the features of the primary display. In one such embodiment, the second display 112 provides for bonus game features, secondary game features, player tracking features, account management interactivity, purchasing of goods, and advertising. According to one embodiment, the second display 112 is a graphical interface, which is the subject of U.S. patent application Ser. No. 10/943,771, filed Sep. 16, 2004, which is hereby incorporated herein by reference.

In one embodiment, the second display 112 includes a touchscreen 122 and is coupled with the electronics assembly 108. In particular, the touchscreen 122 is enabled to provide signals based on a player's alphanumeric input, whereby the signals are processed as inputs by the processor 106. A signal is an electromagnetic quantity by which information can be communicated. In another embodiment (not shown), the second display 112 is coupled with a central computer (not shown). In this regard, player tracking information can be managed either locally via the processor 106 or non-locally via a network (not shown).

As shown in FIG. 1, the second display 112 is mounted to the cabinet 102 such that the second display 112 is rotationally adjustable about a generally horizontal axis 120. In this regard, the second display 112 can be tilted to a variety of positions. In one embodiment, the second display 112 can be rotated in response to an input received via the touchscreen 122. For example, a player can enter a command instructing the display to tilt frontward or backward.

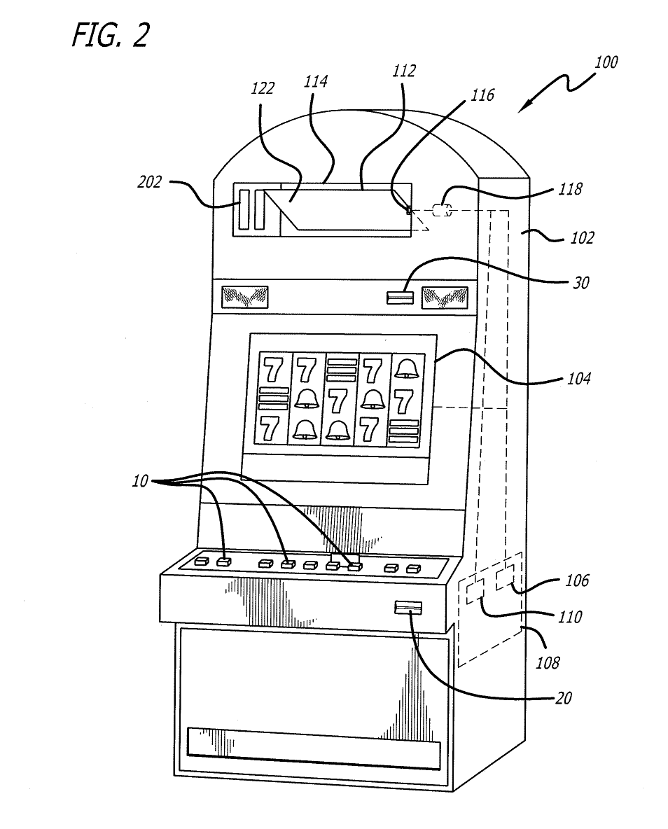

Additionally, a player identifier can be presented to the gaming machine 100 via a card reader 202. For example, the gaming machine 100 of FIG. 2 includes a card reader 202. The card reader 202 is disposed adjacent to the second display 112 and is coupled to the second display 112. In this embodiment, the second display 112 and card reader 202 are upgrades to an existing gaming machine 100 which did not originally provide for network based bonus games.

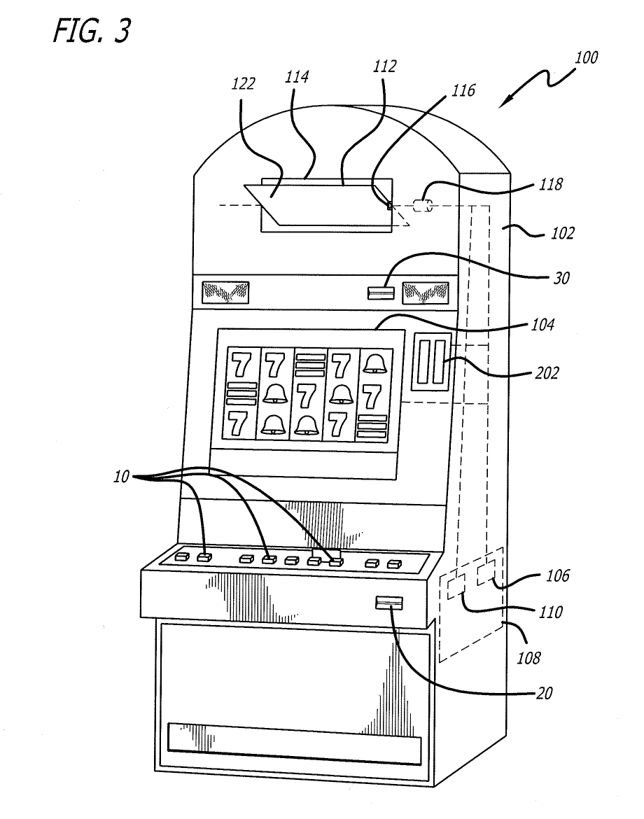

In the embodiment of FIG. 3, the card reader 202 is disposed adjacent to the first display 104 and is coupled with the electronics assembly 108. Accordingly, the electronics assembly 108 is enabled to provide player tracking features, either as a standalone device or as a networked device. In additional embodiments (not shown), the card reader 202 may be replaced with, or may also include, a voucher reader/writer, an RFID interface, or other input and/or output device. As such, the gaming machine 100 can accommodate a variety of media that store and transport player identifiers.

To effectuate the rotation of the second display 112, the gaming machine 100 includes a motor 118. A motor is a device that converts electricity into mechanical energy. Examples of motors include servos, steppers, limited angle torque, and other AC (alternating current) and DC (direct current) motors. The motor 118 is coupled with the controller 110 and attached to the cabinet 102. In one embodiment, the gaming machine 100 is enabled such that the electronics assembly 108 receives a command or selection from a player via the touchscreen 122 to adjust the tilt of the second display 112. In turn, the processor 106 causes the controller 110 to activate the motor 118. Accordingly, the second display 112 is rotated about a pivot, axle, or other member. In additional embodiments (not shown), the command to adjust the tilt of the second display 112 can be provided via voice, a button, a wheel, a trackball, or other input device.

In another embodiment, the tilt of the second display 112 is automatically adjusted based on a signal generated by a sensor 116. The sensor 116 can be attached to, or integrated with the cabinet 102 or the second display 112. A sensor is a device that generates an electrical signal responsive to a physical stimulus. Examples of sensors include an infrared sensor, an ultrasonic sensor, a charged coupled device (CCD), and a complementary metal-oxide semiconductor (CMOS). As shown, the sensor 116 is enabled to generate a signal that is related to a distance.

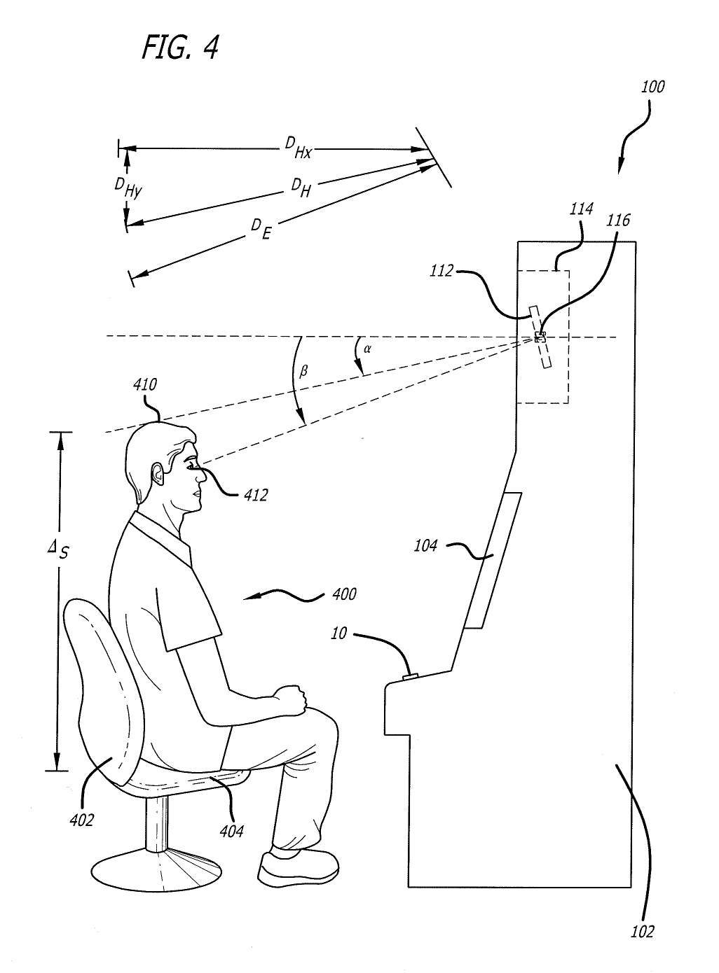

Turning now to FIG. 4, there is shown an embodiment of a gaming machine 100 having a sensor 116 that is attached to the second display 112. Alternatively, the sensor 116 may be positioned on the gaming cabinet 102 near the second display 112. As shown in FIG. 4, the sensor 116 faces a direction that is normal or perpendicular to the second display 112. As a consequence, both the sensor 116 and the second display 112 have the same angle of inclination α. An angle of inclination is a degree of ascent relative to a horizontal plane or axis.

For example, in the embodiment of FIG. 4, the angle of inclination α corresponds to the sensor 116 pointing at a top of a head 410 of a player 400. Accordingly, the sensor 116 generates a signal that is related to a distance D_{H} between the second display 112 and the top of the head of the player 410. In another embodiment, the sensor 116 and the second display 112 are directed at an eye 412 of the player 400, thereby causing the second display 112 to be disposed at an angle of inclination β.

Determination of the angle of inclination α and/or β may be performed by the processor 106 and/or the controller 110. For example, the controller 110 can cause the sensor 116 to rotate through a variety of angles in order to determine what angle of inclination β corresponds with the minimum distance from the sensor 116 to the eye 412 of the player 400. However, in some situations, the eye 412 of the player 400 is undetectable because the player 400 is wearing sunglasses. In this regard, the processor 106 can default to an angle α that corresponds to the top of the head 410 of the player 400.

Alternatively, the angle of inclination of the second display 112 can be set at a predetermined γ degrees in addition to α or β. The predetermined γ can be based on empirical studies which suggest a comfortable viewing angle for the majority of players. In one embodiment, the vertical viewing angle, from an ergonomic perspective, is set between approximately 15 and approximately 20 degrees. In another embodiment, the optimal viewing angle is achieved when a player's viewing direction is perpendicular to the screen. In yet another embodiment, the display 112 is positioned so that a player only needs eye movement of up to 8 degrees upwards and 12 degrees downwards. As such, these embodiments provide a gaming machine 100 that reduces potential fatigue of the eye, neck, and back of a player by maintaining the angle of inclination of the second display 112 within an optimal range for the player.

Nonetheless, other factors can affect the quality of an image shown by the second display 122. For example, the gaming establishment may have a variety of different types of lights and other displays that reflect off of the second display 122, wash out the colors and/or contrast of the second display 122, and cause glare with regard to the second display 122. In order to reduce potential color shift, diminished brightness, glare, and contrast issues, the processor 106 and/or the controller 110 can adjust one or more characteristics of the image based on the angle of inclination. An example of a modifiable characteristic is hue. The term hue refers to a characteristic of color for distinguishing among pairs of colors, e.g., red, yellow, green, and blue. Additionally, picture quality characteristics such as, but not limited to, picture brightness, contrast, sharpness, or color can also be adjusted based on the display's angle of inclination.

In another embodiment, the tilt of the second display 112 can be calculated based on a sitting height D_{S} of the player 400. The sitting height D_{S} is the vertical distance between a top 404 of a seat 402 and the top of the head 410 of the player 400 when the player is sitting on the seat 402. The sitting height D_{S} can be determined via use of a sensor (not shown). In another embodiment, the sitting height D_{S} is determined at a registration station (not shown), e.g., at a kiosk or a booth.

For example, during the registration process, the sitting height D_{S} of the player can be determined with regard to a specific seat at the registration station. The sitting height D_{S} can then be saved in association with the player identifier in a central database, a player card, a voucher, or other media. Accordingly, when the player 400 presents the player identifier to a particular gaming machine 100, the gaming machine 100 can automatically determine an angle of inclination of the second display 112 that corresponds to the player 400.

In order to provide automatic adjustment, the processor 106 first determines an optimum angle of inclination for the second display 112 based on one or more of the following pre-recorded data: a sitting height D_{S} of the player 400, a position of the player 400 relative to a sensor at a kiosk when the player 400 is sitting on a chair of the kiosk, and a position of the chair 402 of the gaming machine relative to the second display 112 of the gaming machine 402. Once the optimum angle is calculated, the controller 110 causes the motor 118 to rotate the second display 112.

In another embodiment, the second display 112 or the electronics assembly 110 causes a calculated angle to be recorded in one or more of a local database, a central database, a player card, a voucher, or other media responsive to the player 400 inputting a command to adjust the second display 112. The angle of inclination that the second display 112 is adjusted to by the player 400 is recorded as the calculated angle. In addition, the calculated angle can be recorded in association with a player identifier of the player 400. In this regard, the angle of inclination of the second display 112 can be automatically adjusted responsive to the player 400 presenting the player identifier or logging in to a gaming machine 100.

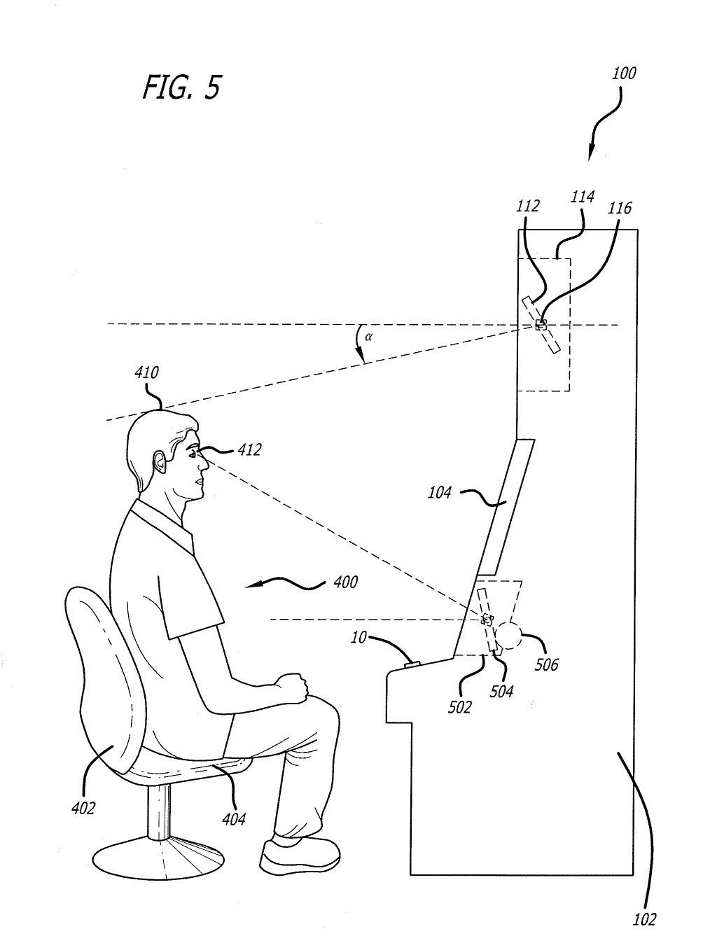

FIG. 5 illustrates an embodiment of a gaming machine 100 having a first second display 112 and a second second display 504. Similar to the embodiment of FIG. 1, the first second display 112 is disposed above the first display 104 and at least partially within a recessed section 114 of the cabinet 102. The second second display 504 is disposed below the first display 104 and at least partially within a recessed section 502 of the cabinet 102.

The gaming machine 100 also includes buttons 10, 15 that function as input mechanisms and may include mechanical buttons, electromechanical buttons, or touch screen buttons. The button functions include, but are not limited to a collect button (or cash-out), select lines button, bet per line button, max bet button, and a spin button. According to one embodiment, the buttons 10, 15 are backlit to indicate whether the button is active. In another embodiment, one input mechanism is a universal button module that provides a dynamic button system adaptable for use with various games, as disclosed in U.S. application Ser. No. 11/106,212, entitled “Universal Button Module”, filed Apr. 14, 2005 and U.S. application Ser. No. 11/223,364, entitled “Universal Button Module”, filed Sep. 9, 2005, which are both hereby incorporated herein by reference. Additionally, other input devices, such as, but not limited to, a touch pad, track ball, mouse, switches, toggle switches, are included with the gaming machine to also accept player input.

In yet another embodiment, a cellular phone or other input device (e.g., PDA), separate and apart, from the gaming machine 100 may also be used to input various player choices and information to enhance the player's interactive experience with the gaming machine. In this embodiment, the gaming machine 100 also includes an IR sensor, RF sensor, BLUETOOTH receiver, or other means for receiving input from a cellular phone or other wireless input devices. Furthermore, inputting information via these devices provides an added level of security as any key presses may be hidden from view. In yet another embodiment, a player may call or send a text message or a short message service (SMS) to the gaming machine.

As shown in FIGS. 1-3, the gaming machine 12 includes a ticket reader/ticket printer slot 20 that is associated with a cashless gaming system (not shown). According to one embodiment, the slot 20 is used for the ticket reader and ticket printer. Accordingly, the same slot 20 may be used to insert and/or issue a ticket. However, in alternate embodiments, separate slots (not shown) may be provided for the ticket acceptor and the ticket printer. In one embodiment, the ticket reader (not shown) of the cashless gaming system is capable of accepting previously printed vouchers, paper currency, promotional coupons, or the like. The ticket printer (not shown) of the cashless gaming system generates vouchers having printed information that includes, but is not limited to, the value of the voucher (i.e., cash-out amount) and a barcode that identifies the voucher. In another embodiment, the gaming machine may allow a player insert credit onto the gaming machine through an electronic funds transfer from a player's account. In this embodiment the slot may be a card reader for reading a credit or debit card from the player.

Additionally, each gaming machine 12 is in communication with a player tracking system (not shown). The player tracking system allows a casino to monitor the gaming activities of various players. The player tracking system typically includes a database of all qualified players (i.e., those players who have enrolled in a player rating or point accruing program). Generally, the database for the player tracking system is separate from the gaming machines. Additionally, the player tracking system is able to store data relating to a player's gaming habits as well as the player's preferences for gaming machine configuration. That is, a player can accrue player points that depend upon the amount and frequency of their wagers. Casinos can use these player points to compensate the loyal patronage of players. For example, casinos may award or “comp” a player free meals, room accommodations, tickets to shows, and invitations to casino events and promotional affairs.

The player tracking system is operatively connected to one or more input components on the gaming machine 100. These input components include, but are not limited to, a player card slots 30 for receiving a player tracking card, a keypad or equivalent, and a display 112. Accordingly, the gaming activity of the players may be tracked. Alternatively, the gaming machine includes no slot at all. If the gaming machine does not include a player card slot, the players may input player identification via a touch screen, keypad, or other input mechanisms that are associated with the player tracking system in lieu of inserting a player tracking card.

In another embodiment, each gaming machine 100 includes an Internet connection or other known network connections to link the plurality of gaming machines together. According to one embodiment, the Internet connection is used for web browsing, prize redemption, or access to other gaming or non-gaming information. With the various gaming machines in communication with one another (or a system host), the gaming machines 100 may participate in the group bonus feature or a tournament game. In one embodiment, the bonus is randomly paid out to a single gaming machine, and alternatively, the bonus is paid out to all or all eligible gaming machines. It has been contemplated that to be eligible, a player must be betting the maximum amount or have played a certain amount of money over a period of time, played for a certain amount of time, or any other determining feature.

The main cabinet 102 of the gaming machine 100 also houses a CPU, circuitry, and software for receiving signals from the player-activated buttons 10 and one or more handles (not shown), operating the games, and transmitting signals to the game display and speakers. In one embodiment, the primary game and the bonus feature are operated by separate processors that are in communication with one another. In yet another embodiment, the primary game and the bonus feature are operated remotely via one or more servers.

In various embodiments, one or more game programs may be stored in a memory (not shown) comprising a read only memory (ROM), volatile or non-volatile random access memory (RAM), a hard drive or flash memory device or any of several alternative types of single or multiple memory devices or structures. Optionally, each gaming machine 100 includes one or more data repositories for storing data. Examples of information stored by the gaming machines 100 include, but are not limited to, accounting data, maintenance history information, short and/or long-term play data, real-time play data, and sound data. In one embodiment, the data repository also stores display content configurations for various games and gaming machines.

One of ordinary skill in the art will appreciate that not all gaming machines have all these components and may have other components in addition to, or in lieu of, those components mentioned here. Furthermore, while these components are viewed and described separately, various components may be integrated into a single unit in some embodiments.

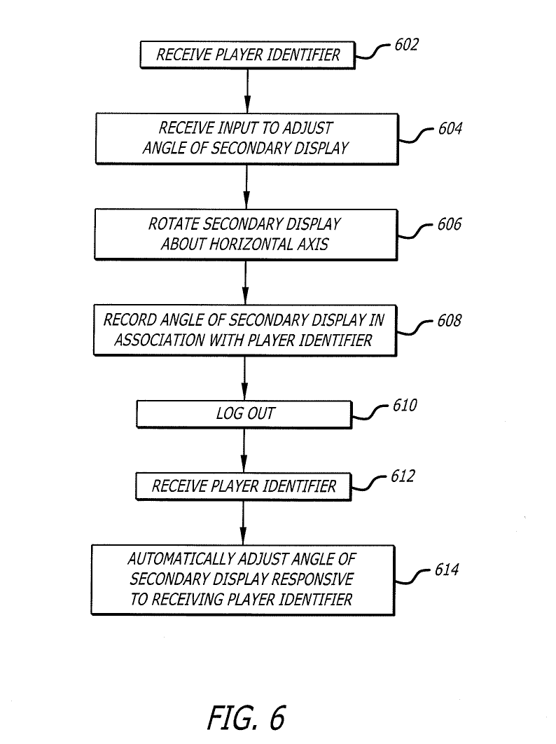

Referring now to FIGS. 6-9, there are shown various embodiments of methods for adjusting the angle of inclination of the second display 112. More specifically, in FIG. 6, there is shown an embodiment of a method of adjusting an inclination of a second display 112 of a gaming machine 100. Preliminarily, a player registers personal information with a gaming establishment and is issued a player identifier.

Next, the player logs in to a player tracking system by providing the player identifier to a gaming machine 100. The player can present the player identifier by swiping a player card, entering an alphanumeric code via a keypad, using a biometric input device, or using another input device. In this regard, the gaming machine receives the player identifier (step 602).

As players desire ergonomic comfort, the player can choose to adjust an angle of inclination of the second display 112 to optimally suit their viewing position. In particular, the player can press a button, touch a touchscreen 122, roll a wheel (not shown) or use another input device (not shown) to communicate their preference. In this regard, the gaming machine 100 receives the input to adjust the angle of the second display 112 (step 604).

In response to receiving the input, the processor 106 and/or the controller 110 cause the motor 118 to rotate the second display 112 about a horizontal axis 120 (step 606). Furthermore, the processor 106 and/or the controller 110 are enabled to receive, process, and cause the angle of inclination of the second display 112 to be recorded as a selected angle. More specifically, the angle of inclination of the second display 112 is recorded in association with the player identifier (step 608). In one embodiment, the angle of inclination is recorded on a local storage device. In addition, the angle of inclination can be recorded on a storage device located on a network and/or on a central computer. Additional relevant data may be stored in association with the angle of inclination, e.g., a gaming machine identifier code.

Upon completion of the player's gaming session, the player logs out of the gaming machine 100 (step 610). However, having recorded the angle of inclination of the second display 122, the selected angle of inclination can be recalled at a later time or date at the same or different gaming machine 100. In this regard, gaming machines 100 can be enabled to automatically adjust the angle of inclination upon receiving the player identifier.

At a later time, e.g., after dinner and a show, the player returns to the gaming machine 100 or a similar gaming machine and chooses to play additional wagering games. The gaming machine 100 can receive a player's input of the player identifier, e.g., via a card reader 202 (step 612). In response, the processor 106 receives from a storage device a selected angle of inclination that is stored in association with the player identifier. With the selected angle of inclination, the processor 106 and/or the controller 110 automatically causes the motor 118 to adjust the angle of inclination of the second display 112 (step 614).

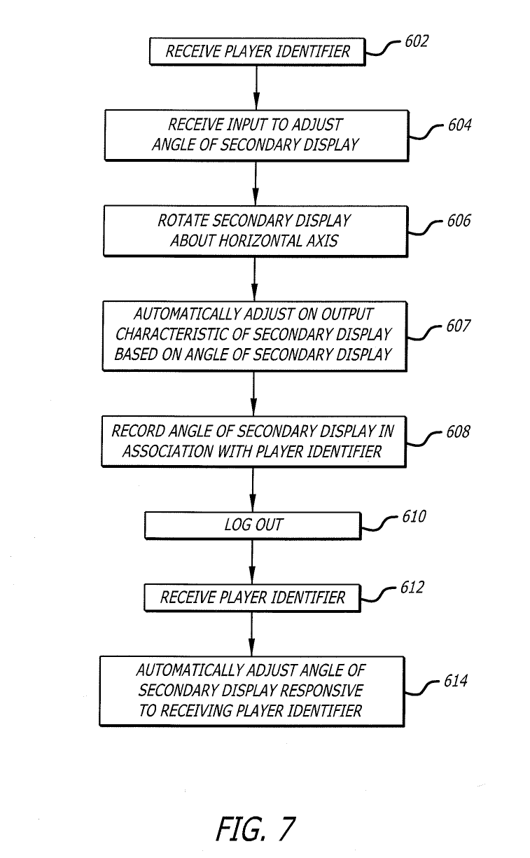

Referring now to FIG. 7, there is shown another embodiment of a method of adjusting an inclination of a second display 112 of a gaming machine 100. In like manner as disclosed embodiment of FIG. 6, when the player instructs the gaming machine 100 to adjust the angle of inclination of the second display 112, the motor 118 rotates the second display 112 about the horizontal axis 120, and the angle of inclination of the second display 112 is recorded in association with the player identifier (step 608). In addition, the controller 110 automatically causes the second display 112 to adjust an output characteristic of an image being displayed (step 607). For example, as the second display 112 is tilted away from overhead lighting and towards a player, the brightness is increased. In this regard, the viewing comfort of the player is optimized.

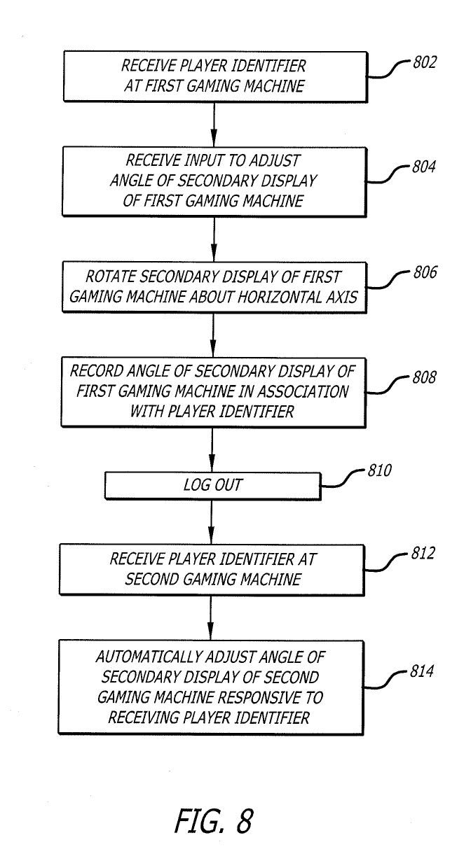

Referring now to FIG. 8, there is shown another embodiment of a method of adjusting an inclination of a second display 112 of a gaming machine 100. In like manner as disclosed in the method of FIG. 6, the player registers with a gaming establishment and establishes a player identifier. Via a login process, a first gaming machine 100 receives the player identifier (step 802).

Next, the player instructs the first gaming machine 100 to adjust the angle of inclination of the second display 112, whereby the first gaming machine 100 receives the input (step 804). In response, the motor 118 rotates the second display 112 about the horizontal axis 120, and the angle of inclination of the second display 112 is recorded in association with the player identifier (step 808). In addition, a gaming machine identifier code associated with the first gaming machine 100 is recorded in association with both the selected angle of inclination and the player identifier. By recording the gaming machine identifier code, characteristics of the corresponding gaming machine 100 can later be referenced for calculation purposes.

Upon completion of the player's gaming session, the player logs out (step 810). Subsequently, the player chooses to play a second gaming machine 100 and inserts a card into a card reader 202 of the second gaming machine 100. In this regard, the second gaming machine 100 receives the player identifier (step 812). Using the player identifier, the processor 106 retrieves the selected angle of inclination and the gaming machine identifier code associated with the first gaming machine 100.

Next, using information related to the physical configurations of the first gaming machine 100 and the second gaming machine 100, the processor 106 correlates the angle of inclination of the second display 112 of the first gaming machine 100 to a modified angle of inclination of the second display 112 of the second gaming machine 100. In response, the angle of inclination of the second display 112 of the second gaming machine 100 is automatically adjusted (step 814) such that the viewing angle by the player at the second gaming machine 100 corresponds to that of the first gaming machine 100.

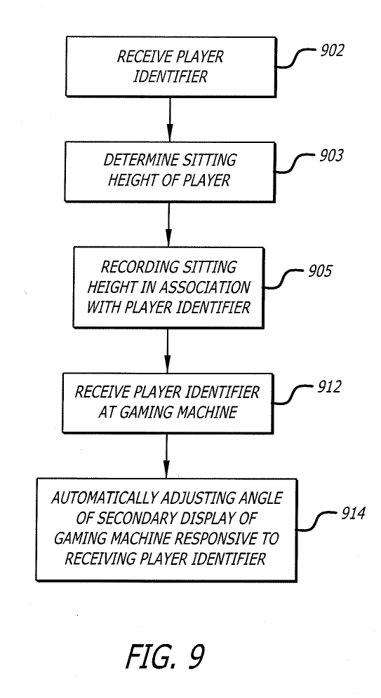

Referring now to FIG. 9, there is shown another embodiment of a method of adjusting an inclination of a second display 112 of a gaming machine 100. In the embodiment of FIG. 9, registration is performed at a registration station or kiosk including a seat for initial data recording. The registration station receives the player identifier (step 902). In order to automatically reconfigure subsequently played gaming machines 100, the registration station first determines a sitting height of the player (step 903). The sitting height can be determined via one or more sensors (not shown). Once determined, the sitting height is recorded in association with the player identifier on one or more of a player card, a network database, and a central computer (step 905).

Subsequently, the player chooses to play a wagering game at a gaming machine 100 and enters a player identifier via a keyboard of the gaming machine 100. In this regard, the gaming machine 100 receives the player identifier (step 912). In response, the angle of inclination of the second display 112 is automatically adjusted (step 914) based on information relating the player's sitting height and an optimum angle of inclination of the second display 112.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A method for tailoring a gaming machine to a player, the method comprising:
receiving a player input via a player interface to tilt a display on a first gaming machine;
pivoting the display about a horizontal axis of the display in response to the player input from the player interface;
saving data relating to the position of the display; and
associating the data with a player identifier for future use on the first gaming machine or a gaming machine having a similar display configuration.

2. The method of claim 1, further comprising:
receiving the player identifier on a second gaming machine;
determining whether the data relating to the position of a display is applicable to the second gaming machine; and
automatically pivoting the display to the position associated with the player identifier when the data is applicable to the second gaming machine.

3. The method of claim 1, wherein the data is saved to a central computer.

4. The method of claim 1, wherein the data is saved to a player tracking card.

5. The method of claim 1, further comprising altering one or more picture quality characteristics in response to the position of the display.

6. The method of claim 5, wherein the picture quality characteristic is a picture hue or picture brightness.

7. A method for customizing a gaming machine to a player, the method comprising:
receiving a player input via a player interface to tilt a display on a first gaming machine;
pivoting the display about a horizontal axis of the display in response to the player input from the player interface;
saving data relating to the position of the display;
associating the data with a player identifier for future use on the first gaming machine or a gaming machine having a similar display configuration;
receiving the player identifier on a second gaming machine;
determining whether the data relating to the position of a display is applicable to the second gaming machine; and
automatically pivoting the display to the position associated with the player identifier when the data is applicable to the second gaming machine.

8. The method of claim 7, wherein the data is saved to a central computer.

9. The method of claim 7, wherein the data is saved to a player tracking card.

10. The method of claim 7, further comprising altering one or more picture quality characteristics in response to the position of the display.

11. The method of claim 10, wherein the picture quality characteristic is a picture hue or picture brightness.

12. A method for customizing a gaming machine to a player, the method comprising:
identifying a top of the player's head relative to an adjustable display;
pivoting the adjustable display to a position such that the player's line of sight is approximately perpendicular to the display; and
saving data to a player account, wherein the data includes the position of the adjustable display.

13. The method of claim 12, further comprising:
receiving a player identifier a gaming machine, the player identifier being associated with the player account; and
pivoting the adjustable display to the position stored with the player account.

14. The method of claim 12, wherein pivoting the adjustable display further comprises calculating the position of the adjustable display relative to the top of the player's head.

15. The method of claim 12, wherein the data is saved to a central computer.

16. The method of claim 12, wherein the data is saved to a player tracking card.

17. The method of claim 12, further comprising altering one or more picture quality characteristics in response to the position of the display.

18. The method of claim 17, wherein the picture quality characteristic is a picture hue or picture brightness.
